(19) United States
(12) Patent Application Publication
(10) Pub. No.: US 2026/0172620 A1
(43) Pub. Date: Jun. 18, 2026

(54) DISPLAY DEVICE CAPABLE OF DISPLAYING A CUSTOMIZED RECOMMENDATION UTTERANCE

(71) Applicant: LG ELECTRONICS INC., Seoul (KR)

(72) Inventors: Hyunseung KIM, Seoul (KR); Jiwon DO, Seoul (KR); Sohyun KIM, Seoul (KR); Jiun OH, Seoul (KR); Gijeong SEONG, Seoul (KR)

(73) Assignee: LG ELECTRONICS INC., Seoul (KR)

(21) Appl. No.: 19/414,477

(22) Filed: Dec. 10, 2025

(30) Foreign Application Priority Data
Dec. 12, 2024 (WO) PCT/KR2024/096818

(51) Int. Cl. H04N 21/422; G10L 15/30; H04N 21/4415; H04N 21/45; H04N 21/482

(52) U.S. Cl. CPC H04N 21/4221; G10L 15/30; H04N 21/4415; H04N 21/4532; H04N 21/482

(57) ABSTRACT

Proposed is a display device capable of displaying a customized recommendation utterance, the display device including a user input interface unit configured to receive a first input, associated with a recommendation utterance request, and a second input, associated with recognition of utterance data of a user, in conjunction with a remote control device, a display configured to display either information or a recommendation utterance, each of which is associated with the utterance data; and a processor configured to enable the display to display a keyword associated with either the utterance data or previous utterance data of the user.

### CROSS-REFERENCE TO RELATED APPLICATION CROSS-REFERENCE TO RELATED APPLICATION

Pursuant to 35 U.S.C. § 119(a), this application claims the benefit of the earlier filing date and the right of priority to PCT Patent Application No. PCT/KR2024/096818, filed on Dec. 12, 2024, the contents of which are incorporated by reference herein in their entirety.

### TECHNICAL FIELD

The present disclosure relates to a display device capable of displaying a customized recommendation utterance. More particularly, the present disclosure relates to an AI system including a display device capable of displaying a customized recommendation utterance and a server.

### BACKGROUND

In recent years, digital TV services using wired or wireless communication networks have grown in popularity. The digital TV services can provide various services that existing analog broadcast services could not provide.

For example, Internet Protocol Television (IPTV) and smart TV services, which are categorized as types of the digital TV services, provide bidirectional communication functionality that enables users to actively select types of programs to be viewed, specify viewing times, and perform viewing-related operations.

In recent years, display devices such as digital TVs have provided various services based on artificial intelligence (AI). In this regard, a display device installed within a household is capable of providing AI services customized for a plurality of users. However, there exists a problem in that providing user-specific recommendations is difficult due to the challenge of distinguishing usage data among users who share the same display device installed in a household.

From the perspective of personal information exposure, a privacy problem exists regarding recommendations, because viewing histories, utterance records, or search records may be exposed to users who share the same display device. In addition, in terms of search time and operational complexity, a problem arises in that direct input of, or searching for, a keyword for viewing requires significant time and effort, thereby hindering the use of various functions provided by the display device.

### SUMMARY

One object of the present disclosure, which is intended to address the above-mentioned problems and other related problems, is to provide an AI system that includes a display device capable of displaying a customized recommendation utterance and a server.

Another object of the present disclosure is to distinguish usage data associated with each of a plurality of users who share the same display device installed in a household, thereby enabling provision of user-specific recommendations.

A further object of the present disclosure is to protect privacy in providing recommendations, without exposing viewing histories, utterance records, or search records to users who share the same display device.

Another object of the present disclosure is to reduce time and effort required for direct input of, or searching for, a keyword for viewing in terms of search time and operational complexity, thereby facilitating the use of various functions provided by a display device.

According to one aspect of the present disclosure, there is provided a display device capable of displaying a customized recommendation utterance, the display device including: a user input interface unit configured to receive a first input, associated with a recommendation utterance request, and a second input, associated with recognition of utterance data of a user, in conjunction with a remote control device; a display configured to display either information or a recommendation utterance, each of which is associated with the utterance data; and a processor configured to enable the display to display a keyword associated with either the utterance data or previous utterance data of the user.

According to an embodiment, when a key value corresponding to a button of the remote control device is received, the processor may generate the recommendation utterance request, may request a history of the previous utterance data from a database in response to the recommendation utterance request, and may request the recommendation utterance from a server on the basis of a history of the utterance data and account information of the user. The processor may receive the recommendation utterance from the server and may control the output of the received recommendation utterance, including the keyword, on the display.

According to an embodiment, in the display device, the processor may include: a recommendation utterance output module configured to output the recommendation utterance by executing an application program when a first input, having a duration shorter than a threshold time, is applied to the button; and a history management module configured to receive the recommendation utterance request from the recommendation utterance output module and receive the history of the utterance data from the database. The history management module may transfer the recommendation utterance, received from the server, to the recommendation utterance output module.

According to an embodiment, in the display device, when a key value corresponding to a power button of the remote control device is received, the recommendation utterance output module may transfer the recommendation utterance request to the history management module. The history management module may transfer a greeting request to a second server and may receive, from the second server, a greeting based on temporal information. The history management module may transfer the received greeting to the recommendation utterance output module. The recommendation utterance output module may output a screen, including the received greeting, on the display.

According to an embodiment, in the display device, when a switch from a powered-off state to a powered-on state first occurs on a per-date basis, the processor may output a screen, including a first greeting, on the display on the basis of the temporal information. When the switch to the powered-on state occurs two or more times, the processor may output, on the display, a screen including a second greeting different from the first greeting. When a first threshold time elapses in the powered-on state, the processor may extract keywords according to utterance frequency derived from the history of the utterance data for each corresponding week. The processor may display the extracted keywords in order of the utterance frequency.

According to an embodiment, in the display device, the processor may further include a voice recognition processing module configured to transfer the recognized utterance data from the remote control device to the server. The voice recognition processing module may perform processing for analysis of the user's intention associated with the recognized utterance data in conjunction with the server when a second input, having a duration equal to or longer than the threshold time, is applied to the button. The voice recognition processing module may control the display of a search result, associated with the recognized utterance data, on a screen of the display on the basis of the result of the processing for analysis of the user's intention.

According to an embodiment, in the display device, the voice recognition processing module may determine, in conjunction with the server, whether the recognized utterance data is voiceprint data of a second user other than the user. When the second user is a registered user, the processor may display an account switch screen, associated with whether to a switch from the user's login-required account to the second user's second login-required account. When a switch input for the switch to the second login-required account is received from the account switch screen, the processor may switch to the second login-required account.

According to an embodiment, in the display device, the processor may request a second recommendation utterance from the server on the basis of a second history of utterance data of the second user and second account information of the second user. The processor may receive the second recommendation utterance from the server and may control the output of the received second recommendation utterance, including a second keyword, on the display.

According to an embodiment, in the display device, the history management module may store the history of the utterance data in the database on the basis of the result of the processing for analysis of the user's intention. The history management module may store a history of content information in the database on the basis of the content information selected from a home screen of the display. The history management module may store a history of second content information in the database on the basis of the second content information selected from an integration search screen of the display.

According to an embodiment, in the display device, the utterance data, the content information, and the second content information, which are to be stored in the database, may each include temporal information including a start time and an end time, a keyword, a genre code, an intention type, and information on an application being executed on the display device. The keyword may be one of the following: a keyword derived from the utterance data, the content, or the name of the second content.

According to an embodiment, in the display device, the voice recognition processing module may control the storage of the history of the utterance data in the database. The history of the utterance data may include the user's account, an STT result, the date and time of an utterance, the corresponding day of the week, and temporal information.

According to an embodiment, in the display device, when the key value corresponding to the button is received, the processor may extract information about a currently logged-in account from the database, may extract keyword information associated with an utterance used by the user, on the basis of the current day of the week and the temporal information. The processor may control the output of the received recommendation utterance, including the keyword, on the display on the basis of the keyword information.

According to an embodiment, in the display device, the processor may transfer information about a currently logged-in account, the current time, and the user's access record to the second server. The second server may transfer the information about the currently logged-in account to a UPP server, may receive customer segment information from the UPP server, and may transfer, to the processor, a welcome message generated on the basis of the current time, the customer segment information, and the user's access record. The processor may control the output of the welcome message on the display.

According to an embodiment, in the display device, when the key value corresponding to the button is received, the processor may transfer, to the second server, the current time, information about a connected apparatus, information about a program currently being viewed, and information about an application currently in use. The processor may receive, from the second server, usage tip information customized on the basis of the current time, the information about the connected apparatus, the information about the program currently being viewed, and the information about the application currently in use. The processor may display at least one sentence associated with a usage tip on the display on the basis of the customized usage tip information.

According to an embodiment, in the display device, the processor may acquire the information about the application in use and the account information of the user. The processor may output at least one sentence, associated with searching for and playing back content items provided by the application, on a screen of the display on the basis of the information about the application currently in use, the history of the utterance data, and the account information of the user.

According to an embodiment, in the display device, the processor may acquire state information of the connected apparatus and environmental information of a region where the display device and the connected apparatus are arranged. The processor may output at least one sentence, associated with the usage tip for controlling the operation of the connected apparatus, on a screen of the display on the basis of the state information and the environmental information.

According to an embodiment, in the display device, the processor may receive, from the server, broadcast information associated with a program to be viewed by the user. The processor may transfer the broadcast information to a third server that extracts an association keyword associated with the broadcast information. The third server may receive detailed program information associated with the broadcast information from a fourth server of an integrated broadcasting information system. The processor may output the association word associated with the broadcast information on the display on the basis of the detailed program information.

According to an embodiment, in the display device, when a first user is detected in a state where the first user's first login-required account, among a plurality of user accounts, is logged in, the processor may request a first recommendation utterance from the server on the basis of a first history of first utterance data of the first user and first account information of the first user. When a second user is detected in a state where the second user's second login-required account, among the plurality of user accounts, is logged in, the processor may request a second recommendation utterance from the server on the basis of a second history of second utterance data of the second user and second account information of the second user. The first user may be detected by detecting a first identifier of the first user's first device or through the first user's voiceprint data. The second user may be detected by detecting a second identifier of the second user's second device or through the second user's voiceprint data.

According to an embodiment, in the display device, when the second user is detected instead of the first user in the state where the first login-required account is logged in, the processor may request the second recommendation utterance from the server on the basis of the second history and the second account information. When the first user and the second user are detected in the state where the first login-required account is logged in, the processor may request a first recommendation utterance and the second recommendation utterance from the server on the basis of the first history, the second history, the first account information, and the second account information. The processor may display a common recommendation utterance on the display on the basis of a keyword common to the first recommendation utterance and the second recommendation utterance. The processor may display the first recommendation utterance after the common recommendation utterance on the basis of the first user's first keyword. The second may be registered as having a familial relationship with the first user.

According to the present disclosure, a recommendation customized for each user can be provided by managing usage data for each account. Furthermore, user identification through voiceprint recognition enables data learning for each user solely through utterance without the need for a separate login process.

According to the present disclosure, the customized recommendation can be immediately received by pressing an AI key at any time and in any location. Enhancing recommendation accuracy through advanced logic can significantly reduce search time, thereby enabling execution of a desired function or access to desired content.

According to the present disclosure, either a setting or association information optimized for content currently being viewed can be provided. Furthermore, a usage tip for enhancing the usefulness of an application currently in use can be provided, thereby making the TV viewing experience more immersive and enjoyable.

### BRIEF DESCRIPTION OF THE DRAWINGS

Description will now be given in detail according to exemplary embodiments disclosed herein, with reference to the accompanying drawings:

FIG. 1 is a block diagram illustrating the configuration of a display device according to an embodiment of the present disclosure;

FIG. 2 is a diagram that is referenced to describe a content server according to an embodiment of the present disclosure;

FIG. 3 is a diagram that is referenced to describe an AI system including the display device according to the present disclosure;

FIG. 4 is a flowchart illustrating an operation between each module of the display device according to the present disclosure, which displays a customized recommendation utterance, and a server;

FIG. 5 is a flowchart illustrating an operation between each module of the display device according to the present disclosure, which is configured to recognize utterance data or display the customized recommendation utterance, and the server;

FIG. 6 is a diagram illustrating the configuration of an AI system that includes the display device according to the present disclosure, the display device receiving, from a separate server, and displaying the received greetings to the screen;

(A), (b), and (c) of FIG. 7 are views, each illustrating a screen that is output on the display device over the passage of time in a powered-on state;

FIG. 8 is a diagram illustrating the configuration of the display device configured to store historical information regarding the analysis of a user's intention through the utterance data and historical information regarding content selected from a home screen and an integrated search screen;

FIG. 9A is a view illustrating an initial screen that is displayed when a specific user logs into their login-required account. FIG. 9B is a view illustrating a screen for changing profiles of a plurality of users;

FIG. 10 is a diagram illustrating a recommendation service, according to an embodiment, which is customized based on the user or situation;

FIG. 11 is a diagram illustrating a configuration, according to an embodiment, which provides a usage tip service customized based on the user or situation;

FIGS. 12A and 12B are views, each illustrating a screen of the display device that displays state information of an apparatus connected to the display device;

FIG. 13 is a diagram illustrating the configuration of an AI system, according to an embodiment, that provides a service for recommending an associated keyword based on broadcast information;

FIG. 14 is a flowchart illustrating a method of displaying a customized recommendation utterance, the method being performed by the display device and by the AI system including the display device; and

FIG. 15 is a flowchart illustrating a method of displaying an association search result based on the analysis of the user's intention identified through voice recognition, the method being performed by the display device and by the AI system including the display device.

### DETAILED DESCRIPTION OF THE EMBODIMENTS

Technical terms used in the present specification are intended solely to describe specific embodiments and are not intended to limit the present disclosure. In addition, terms expressed in the singular form in the present specification should be construed to include the plural form unless the context clearly dictates otherwise. The terms “module” and “unit” used in the following description are assigned or used interchangeably solely for convenience in drafting the present specification and are not intended to denote any distinct meanings or roles in and of themselves.

The expression “is configured from” or “includes constituent elements or steps,” used in the present specification, should not be construed to require inclusion of all of the constituent elements or steps. Rather, this expression should be interpreted to mean that some of the constituent elements or steps may be omitted, and additional elements or steps may be included.

In addition, in describing the technology disclosed in the present disclosure, when it is determined that a detailed description of known technology in the art may obscure or detract from the nature and gist of the present disclosure, such description is omitted from the present specification.

In addition, the accompanying drawings are merely provided to facilitate understanding of the embodiments disclosed in the present specification and shall not be construed as limiting the technical idea disclosed in the present specification. Furthermore, any modifications, equivalents, or substitutions of constituent elements, to the extent falling within the technical scope of the present disclosure, are intended to be encompassed within the scope of the present disclosure. In addition, not only the embodiments described below but also combinations of such embodiments, as modifications, equivalents, or substitutions, may be encompassed within the technical idea and scope of the present disclosure.

The embodiments disclosed in the present specification may be described in detail below with reference to the accompanying drawings.

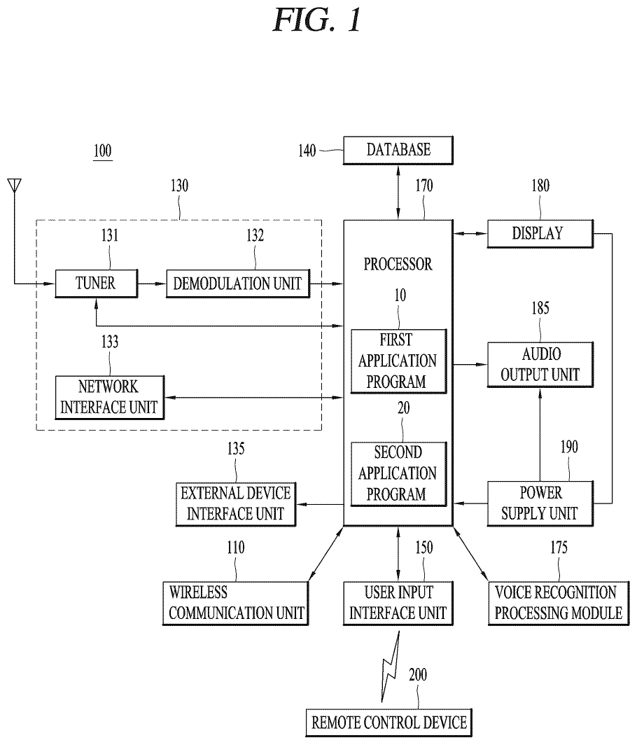

FIG. 1 is a block diagram illustrating a configuration of a display device 100 according to an embodiment of the present disclosure.

With reference to FIG. 1, the display device 100 may include a broadcast reception unit 130, an external device interface unit 135, a database 140, a user input interface unit 150, a processor 170, a wireless communication unit 110, a voice recognition processing module 175, a display 180, an audio output unit 185, and a power supply unit 190.

The broadcast reception unit 130 may include a tuner 131, a demodulation unit 132, and a network interface unit 133.

The tuner 131 may select a broadcast station with a specific broadcast channel according to a command for channel-based broadcast station selection. The tuner 131 may receive a broadcast signal over a specific broadcast channel from the selected broadcast station.

The demodulation unit 132 may separate the received broadcast signal into a video signal, an audio signal, and a data signal associated with a broadcast program and may demodulate the video signal, the audio signal, and the data signal, which result from this separation, into an output-enabled format.

The network interface unit 133 may provide an interface for connecting the display device 100 to a wired or wireless network of which examples include an Internet network. Through the network interface unit 133, data may be transmitted or received to or from another user or another electronic device over a connected network or another network linked to the connected network.

The network interface unit 133 may have access to a predetermined web page over a connected network or another network linked to the connected network. That is, the network interface unit 133 may have access to a predetermined web page. Through the network interface unit 133, data may be transmitted or received to or from a specific server.

Then, through the network interface unit 133, content or data that are provided by a content provider or a network manager may be received. That is, content, such as a movie, an advertisement, a game, VOD, or a broadcast signal, along with information associated with the content, may be received over a network through the network interface unit 133 from a content provider or a network manager.

In addition, through the network interface unit 133, firmware update information and an update file that are provided by the network manager may be received, and data may be transmitted to an Internet or content provider, or to the network manager.

Through the network interface unit 133, a desired application may be selected and received over a network from among applications that are available to the public.

Through the external device interface unit 135, an application or an application list may be received from an adjacent external device, and the received application or application list may be transferred to the processor 170 or the storage unit 140.

The external device interface unit 135 may establish a connection path between the display device 100 and the external device. Through the external device interface unit 135, one or more of the following may be received and transferred to the processor 170: image or audio data, each of which is output from the external device connected to the display device 100 in a wireless or wired manner. The external device interface unit 135 may include a plurality of external input terminals. The plurality of external input terminals may include an RGB terminal, one or more High Definition Multimedia Interfaces (HDMI) terminals, and a component terminal.

An image signal of the external device that is input through the external device interface unit 135 may be output through the display 180. A voice signal of the external device that is output through the external device interface unit 135 may be output through the audio output unit 185.

The external device connectable to the external device interface unit 135 may, for example, be one of the following: a set-top box, a Blu-ray player, a DVD player, a game device, a sound bar, a smartphone, a PC, a USB memory device, or a home theater.

In addition, some of the content data stored in the display device 100 may be transmitted to a user selected from among other users pre-registered with the display unit 100 or to an electronic device selected from among other electronic devices pre-registered therewith.

A program for processing and controlling each signal within the processor 170 may be stored in the database 140. Furthermore, an image, voice, or data signal, each of which is signal-processed, may be stored in the database 140.

In addition, an image, voice, or data signal, each of which is input from the external device interface unit 135 or the network interface unit 133, may also be stored in the database 140 through a temporary storage function. Furthermore, information about a predetermined image may also be stored in the database 140 through a channel memory function.

An application or an application list, each of which is input from the external device interface unit 135 or the network interface unit 133, may be stored in the storage unit 140.

Content files (a moving image file, a still image file, a music file, a text file, an application file, and the like) stored in the storage unit 140 may be played back on the display device 100 for user viewing.

Through the user input interface 150, a signal that is input by a user may be transferred to the processor 170, and a signal may be transferred from the processor 170 to the user. For example, the user input interface 150 may receive control signals for powering on or powering off, channel selection, screen setting, and similar functions from a remote control device 200 and process the received control signals in compliance with various communication standards, such as Bluetooth, Ultra-Wideband (UWB), ZigBee, Radio Frequency (RF), and Infrared (IR). Alternatively, the user input interface 150 may process a control signal from the processor 170 for transmission to the remote control device 200.

In addition, through the user input interface 150, a control signal that is input from local keys (not illustrated), such as a power key, a channel key, a volume key, and a setting key, may be transferred to the processor 170.

An image signal that is image-processed in the processor 170 may be input into the display 180, and an image corresponding to the image signal may be displayed thereon. In addition, the image signal that is image-processed in the processor 170 may be input into an output device through the external device interface unit 135.

The voice signal that is processed in the processor 170 may be audio-output to the audio output unit 185. In addition, the voice signal that is processed in the processor 170 may be input into the external output device through the external device interface unit 135.

Moreover, the processor 170 may control the overall operation of the display device 100.

In addition, the processor 170 may control the display device 100 by executing either a user command that is input through the user input device 150 or an internal program. The processor 170 may enable an application or an application list, each of which is desired by the user, to be downloaded into the display device 100 by making a connection to a network. The processor 170 may be configured to control the display device 100 by executing at least one application program. Execution of a first application program 10 may enable determination, on the basis of the viewing history and playback time for specific content, as to whether such content has been purchased, played back, refunded, resold, or subjected to similar actions. Execution of a second application program 20 may enable information about the playback history and playback time for specific content and other related information to be stored and managed.

The processor 170 enables channel information or the like, which is selected by the user, together with the processed image or voice signal, to be output on the display 180 or through the audio output unit 185.

In addition, in response to an external device image playback command received through the user input interface 150, the processor 170 may enable an image signal or a voice signal, each of which is input from an external device, for example, a camera or a camcorder through the external device interface unit 135, to be output on the display 180 or through the audio output unit 185.

The processor 170 may control the display 180 such that an image is displayed thereon. For example, the processor 170 may control the display 180 such that a broadcast image input through the tuner 131, an external input image input through the external device interface unit 135, an image input through the network interface unit, or an image stored in the storage unit 140 is displayed thereon. In this case, the image displayed on the display 180 may be a still image or a moving image and may be a 2D image or a 3D image.

In addition, the processor 170 controls the display unit 180 such that content stored within the display device 100, received broadcast content, or external input content, input from the outside, is played back. Such content may be in various formats, such as a broadcast image, an external input image, an audio file, a still image, an image from an accessed web source, and a text file.

The wireless communication unit 110 may perform communication with an external apparatus through wired or wireless communication. The wireless communication unit 110 may perform short-range communication with the external apparatus. To this end, the wireless communication unit 110 may support short-range communication using at least one of the following technologies: Bluetooth™, Bluetooth Low Energy (BLE), Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, or Wireless Universal Serial Bus (USB). The wireless communication unit 110 may support wireless communication over short-range wireless area networks between the display device 100 and a wireless communication system, between the display device 100 and a different display device 100, or between the display device 100 and a network on which the display device 100 or an external server is located. The short-distance wireless communication may be short-range Wireless Personal Area Networks.

The different display device 100 here may be a mobile terminal, such as a wearable device (for example, a smartwatch, smart glasses, or a head-mounted display (HMD)) or a smartphone, each of which is capable of interchanging data with (or operating in conjunction with) the display device 100 according to the present disclosure. The wireless communication unit 110 may detect (or recognize) a communication-capable wearable device in the vicinity of the display device 100. Moreover, in a case where the detected wearable device is a device authenticated to communicate with the display device 100 according to the present disclosure, the processor 170 may transmit at least one portion of the data processed in the display device 100 to the wearable device through the wireless communication unit 110. Therefore, a user of the wearable device may use the data processed in the display device 100 through the wearable device.

The voice recognition processing module 175 may acquire audio. The voice recognition processing module 175 may include at least one microphone (not illustrated) and, through the microphone (not illustrated), may acquire audio in the vicinity of the display device 100.

The display 180 may convert an image signal, a data signal, and an OSD signal, all of which are processed in the processor 170, into respective RGB signals, thereby generating drive signals. Alternatively, the display unit may convert an image signal, a data signal, and the like, all of which are received in the external device interface unit 135, into respective RGB signals, thereby generating drive signals.

The display device 100 illustrated in FIG. 1 is merely an embodiment of the present disclosure. Therefore, depending on the specifications of the display device 100 as actually embodied, some of the illustrated constituent elements may be integrated, omitted, or separated into individual constituent elements.

That is, according to need, two or more constituent elements may be integrated into a single constituent element, or one constituent element may be separated into two or more constituent elements. In addition, the function performed in each block is merely for describing an embodiment of the present disclosure, and a specific operation or device for performing such a function does not impose any limitation on the scope of the claims of the present disclosure.

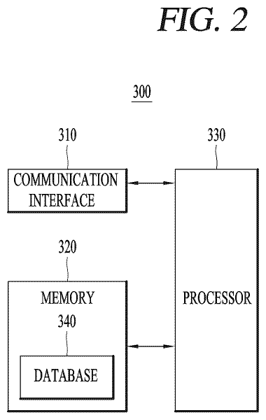

FIG. 2 is a diagram that is referenced to describe a server 300 according to an embodiment of the present disclosure.

The server 300 may provide a recommendation service for recommending content or a service favorable to a viewer who uses the display device 100.

The server 300 may include a communication interface 310, a memory device 320, and a processor 330.

The server 300 may transmit and receive data to and from at least one display device 100 through the communication interface 310 over a wired or wireless communication network.

The memory device 320 may be configured to include a database 340 or to operate in conjunction with the database 340. Information associated with content played back on each device may be stored in the database 340. For example, content playback information, content setting information, or application installation information, each of which is associated with the identification information of each device, may be stored in the database 340.

In a case where a content recommendation request is received from the display device 100 or an external device, the processor 330 may recommend content optimized for the requesting device on the basis of data stored in the database 340.

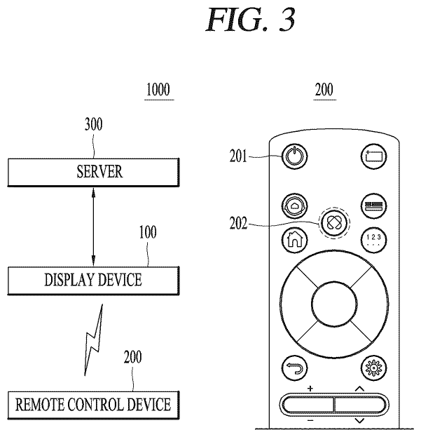

FIG. 3 is a diagram that is referenced to describe an AI system 1000 including the display device 100 according to the embodiment of the present disclosure.

The AI system 1000 may include at least one display device 100, at least one remote control device 200, and the content server 300.

The processor 170 of the display device 100 may play back content.

In addition, the processor 170 may generate content playback information about the played-back content. In addition, the processor 170 may generate the content setting information, which is information about image quality, volume, and the presence or absence of a preference channel.

The content playback information may include at least one of the following: content identification information about the played-back content, content genre information, information about starting point in time of content playback, information about ending point in time of content playback, or the total content playback time.

The content setting information may include at least one of the following:
image quality information, which is set for content during playback, volume information, or preference channel information about whether the user has registered a channel, over which content is provided, as a preference channel.

The processor 170 may transmit the device identification information of the display device 100, the generated content playback information, and the generated content setting information to the server 300 through the communication interface 310. The device identification information may be a unique identification number for distinguishing the display device 100 from other devices.

The content server 300 may store the content playback information and the content setting information, which are received from the display device 100, in a content information database 321 in a manner that is associated with the device identification information.

The processor 170 may receive a content recommendation command, as an input, through the user input unit interface unit 150 or the voice recognition processing module 175.

In a case where the content recommendation command is received as an input, the processor 170 may transmit the device identification information of the display device 100 and the content recommendation request to the server 300 through the communication interface 310.

Through the communication interface 310 of the server 300, the device identification information and the content recommendation request may be received from the display device 100.

The processor 330 of the server 300 may acquire the content playback information and the content setting information, which are associated with the display device 100, from the content information database 321 on the basis of the device identification information.

The processor 330 may generate content recommendation information and recommendation setting information for the display device 100 on the basis of the content playback information and the content setting information. The content recommendation information may include recommendation content identification information and recommendation content genre information about at least one recommendation content item. In addition, the recommendation setting information may include recommendation image-quality setting information and preference channel information.

The processor 330 may transmit the content recommendation information and the recommendation setting information to the display device 100 through the communication interface 310.

The processor 330 may transmit the content recommendation information and the recommendation setting information to the display device 100 through the communication interface 310.

The processor 170 may display at least one recommendation content item on the basis of the received content recommendation information. In addition, when a command for playing back recommendation content is input through the user input interface unit 150 or the voice recognition processing module 175, the processor 170 may play back the recommendation content after setting the image quality of the recommendation content, which is to be played back, on the basis of the received recommendation setting information.

The processor 170 may play back the recommendation content after setting the image quality thereof, and, in a case where the user inputs a change to the preference channel, may make a change to the preference channel on the basis of the preference channel information.

The display device 100 may mirror the content whose playback is in progress to the external apparatus. Examples of the external device may include a different display device and a mobile device. In this case, content that is mirrored may be viewed through the external apparatus. Therefore, viewing information about the content that is mirrored is necessary as foundational data for recommending content for display on the external apparatus.

In a case where the display device 100 performs a mirroring operation for display on the external equipment, a control command for controlling the display device 100 may be received from the external apparatus. Examples of the control command may include a content change command for changing playback content from first content to second content. In a case where the content change command is received, the display device 100 may play back content resulting from the change. In this case, the display device 100 needs to transmit the content playback information about the content resulting from the change to the server 300, as information for recommending content for display on the external apparatus.

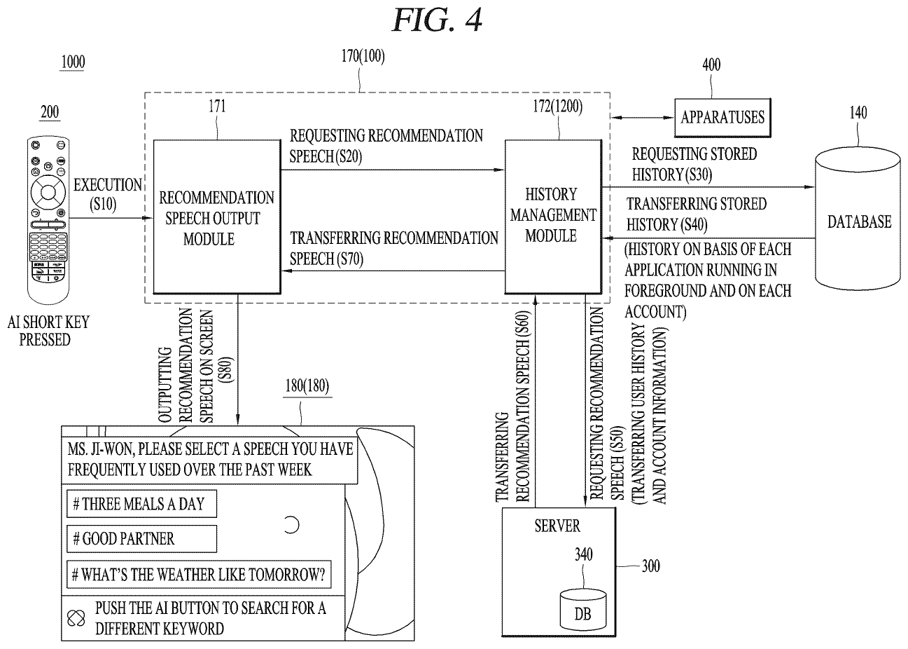

The display device 100 according to the present disclosure, which displays a customized recommendation utterance, and an AI system including the display device 100 will be described below. In this regard, FIG. 4 is a flowchart illustrating an operation between each module of the display device 100 according to the present disclosure, which displays the customized recommendation utterance, and the server 300.

With reference to FIGS. 1 to 4, the display device 100 according to the present disclosure, which operates in conjunction with utterance data, is described. The display device 100 may be configured to include the user input interface unit 150, the processor 170, and the display 180.

The user input interface unit 150 may be configured to receive a first input associated with a recommendation utterance request by operating in conjunction with the remote control device 200. The user input interface unit 150 may be configured to receive a second input associated with the recognition of the utterance data of the user by operating in conjunction with the remote control device 200. In this regard, the first input and the second input may correspond to inputs to specific buttons of the remote control device 200. For example, the first input and the second input may correspond to different types of inputs to an AI shortcut key 202 of the remote control device 200. The first input may correspond to a short press, lasting for a first time shorter than a threshold time of the AI shortcut key 202. The second input may correspond to a long press, lasting for a second time equal to or longer than the threshold time of the AI shortcut key 202.

The display 180 may be configured to display either information or a recommendation utterance, each of which is associated with the utterance data. The processor 170 may be configured to enable the display 180 to display a keyword associated with either the utterance data or previous utterance data of the user.

The processor 170 may be configured to generate the recommendation utterance request when receiving a key value corresponding to a button of the remote control device 200. In this regard, the button of the remote control device 200 may correspond to the AI short key 202 illustrated in FIG. 3. When the AI shortcut key 202 is pressed for the first time shorter than the threshold time, the processor 170 may recognize this press as a first input for a short press. The processor 170 may activate an AI concierge mode that recommends customized keywords and features in response to the first input.

When the AI shortcut key 202 is pressed for the second equal to or longer than the threshold time, the processor 170 can recognize this press as a second input for a long press and hold. The processor 170 may activate an AI voice recognition mode that recognizes the utterance data (voice data) of the user in response to the second input.

In the AI concierge mode, the processor 170 may acquire a history of the previous utterance data of the user and user information in order to receive the recommendation utterance request from the server 300. In this regard, the history of the utterance data is not limited to utterance data based on the user's voice recognized through the display device 100. The history of the utterance data may include a history of utterance data regarding other electronic devices. The history of the utterance data may include a history of utterance data regarding voice-recognizable home appliances or mobile terminals.

Accordingly, the processor 170 may acquire the user's voice recognized through the display device 100, as well as a history of utterance data of an apparatus 400 connected to the display device 100 and user information related to the utterance data. The apparatuses 400 connected to the display device 100 may be a plurality of home appliances that operate in conjunction with the display device 100. In addition, the processor 170 may acquire a history of utterance data of an electronic device registered through the display device 100, which is a user terminal, for example, a mobile terminal, and user information related to the utterance data. In this regard, the display device 100 may operate as a home hub that controls the plurality of home appliances. Therefore, respective histories of utterance data of a plurality of home appliances that operate in conjunction with the display device 100 may be stored in the database 140.

The processor 170 may request the history of the previous utterance data from the database 140 in response to the recommendation utterance request. The processor 170 may request a recommendation utterance from the server 300 on the basis of the history of the utterance data and account information of the user.

The processor 170 may be configured to receive the recommendation utterance from the server 300. The processor 170 may control the display 180 to output the received recommendation utterance that includes a keyword associated with the previous utterance data.

The processor 170 may be configured to include a recommendation utterance output module 171 and a history management module 172. In this regard, the recommendation utterance output module 171 may be implemented as an AI concierge application program that outputs a recommendation utterance on a screen of the display 170. The history management module 172 manages historical information associated with the user's previous utterance data, receives a recommendation utterance that varies according to the historical information and a user account, and transfers the received recommendation utterance to the recommendation utterance output module 171.

The history management module 172 is not limited to being implemented in the display device 100 and may be modified depending on the application. A history management module 1200, which manages the historical information associated with the user's previous utterance data in the AI system 1000, may be implemented as an external entity separate from the display device 100. The history management module 1200 may be implemented in an electronic device, such as a mobile terminal, a plurality of home appliances that operate in conjunction with the display device 100, or the server 300. The history management module 1200 may be implemented in a mobile terminal, electronic appliances, the database 140, the database 340, the servers 300, other databases, other servers, integration servers, or other equivalent devices.

When a button (e.g., the AI shortcut key 202) on the remote control device 200 is pressed, the recommendation utterance output module 171 may be configured to execute an application program 10, thereby outputting a recommendation utterance. The history management module 172 may receive the recommendation utterance request from the recommendation utterance output module 171 and transfer the recommendation utterance request to the database 140. The history management module 172 may be configured to receive the history of the utterance data from the database 140. The history management module 172 may transfer a recommendation utterance, received from the server 300, to the recommendation utterance output module 171.

In this regard, when the first input is applied to the AI shortcut 202 of the remote control device 200, an execution input may be transferred from the remote control device 200 to the recommendation utterance output module 171 (S10). The recommendation utterance output module 171 may deliver the recommendation utterance request to the history management module (172) (S20). The history management module 172 may request the historical information stored in the database 140 (S30). In response to a request for the stored historical information, the database 140 may transfer historical information, selected from among pieces of stored historical information, to the history management module 172. In this regard, the selected historical information may be historical information that varies according to an application program being currently being executed in the foreground and a login-required account (user account). For example, the selected historical information may be historical information about the previous utterance data for a specific application program that is currently being executed by a currently logged-in user, among a plurality of users.

The history management module 172 may transfer the recommendation utterance request, including user history and account information, to the server 300 (S50). In response to the recommendation utterance request, the server 300 may select or generate a specific recommendation utterance from among recommendation utterances stored in the database 340. The server 300 may transfer a recommendation utterance, selected or generated on the basis of the user history and the account information, to the history management module 172 (S60). The history management module 172 may transfer the recommendation utterance, received from the server 300, to the recommendation utterance output module 171 (S70). The recommendation utterance output module 171 may output to a screen of the display 180 the recommendation utterance including keywords, the recommendation utterance being received from the history management module 172 (S80). In this regard, a sentence (e.g., Ms. Ji-Won, please select an utterance you have frequently used over the past week) that includes the user's name may be displayed on the screen.

The sentence including the user's name may be displayed in a first region, and recommendation utterances, which are based on the user's utterance history, may be displayed in a second region. The recommendation utterances may be displayed with the keyword being combined with a hashtag. The recommendation utterances may be displayed such that a sentence including the keyword is displayed in combination with the hashtag. Respective keywords of the recommendation utterances may be first content and second content (a first program and a second program) that may be viewed through the display device 100. Additionally, the keyword of the recommendation utterance may be a sentence uttered by the user, for example, “What's the weather like tomorrow?”

Therefore, the display device according to the present disclosure, which displays the customized recommendation utterance, may be referred to as an AI concierge that performs an AI function. The AI concierge may provide a user segment or a situation-dependent customized greeting when the display device 100 is powered on. In addition, while the display device 100 is in use, a recommendation utterance, including user-specific and situation-based customized keywords, may be recommended according to the user's intention and the usage context. A recommendation utterance may be displayed on a screen of the display device 100 in order to recommend a setting, content, and similar items, as well as a keyword and a specific function.

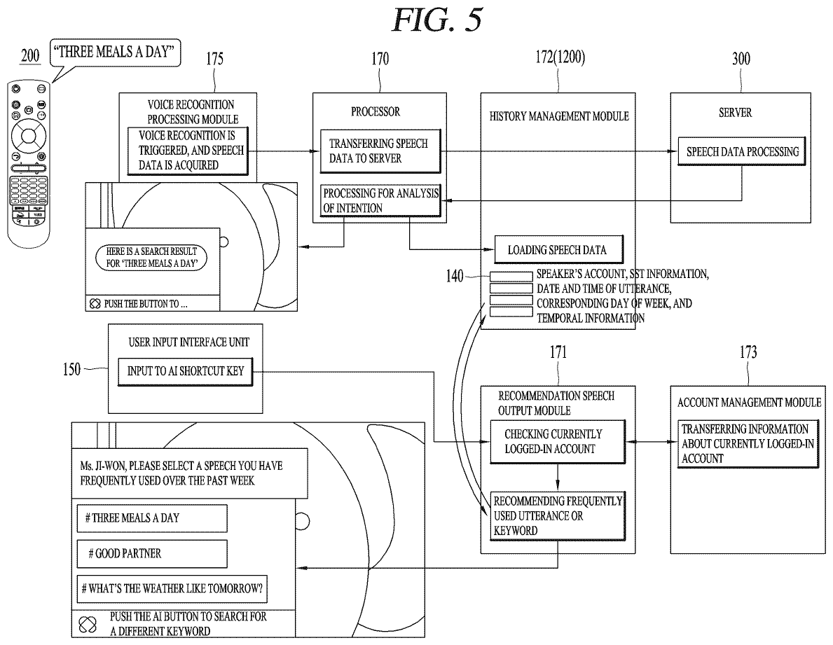

The display device 100 according to the present disclosure may be configured to recognize utterance data and a customized recommendation utterance through the remote control device 200. In this regard, FIG. 5 is a flowchart illustrating an operation between each module of the display device 100 according to the present disclosure, which is configured to recognize utterance data or display the customized recommendation utterance, and the server 300.

With reference to FIGS. 1 to 5, the display device 100 according to the present disclosure, which operates in conjunction with the utterance data, is described.

Regarding the recognition and loading of the utterance data, each constituent element of the display device 100 may operate in conjunction with the remote control device 200 and the server 300. In a state where the second input, having a duration equal to or longer than the threshold time, is applied to a specific button of the remote control device 2000, the user may utter a first keyword of a first program. The first keyword of the first program may correspond to the first content “Three meals a day.”

The utterance recognition processing module 175 is configured to perform an utterance-recognition trigger operation to enable recognition of the user's voice through the remote control device 200, and to acquire utterance data corresponding to the user's voice in response to the utterance-recognition trigger operation. In a state where the second input, having a duration equal to or longer than the threshold time, is applied to a specific button of the remote control device 2000, the voice recognition processing module 175 may acquire the utterance “Three meals a day.” The processor 170 may display the sentence “Here is a search result for ‘Three meals a day’” in conjunction with the voice recognition processing module 175.

The processor 170 may display, on the screen, utterance data and the result of processing for analysis of the utterance data with respect to intention. The processor 170 may display, on a first screen of the display 180, the sentence “Here is a search result for ‘Three meals a day,’” and a search result for text corresponding to the acquired utterance.

The processor 170 may transfer the acquired utterance data to the server 300. The server 300 may perform processing for analysis of the transferred utterance data with respect to intention. The server 300 may perform natural language processing (NLP) to analyze the utterance data with respect to intention. The server 300 may perform processing for analysis of the utterance data with respect to intention through morphological analysis, syntactic analysis, semantic analysis, and discourse analysis of the utterance data. The processor 170 may receive, from the server 300, the result of the processing for analysis of the utterance data with respect to the utterance data. The history management module 172 may store, in the database 140, the utterance data that has undergone the processing for analysis with respect to intention. Historical information regarding the utterance data stored in the database 140 in conjunction with the history management module 172 may include utterance data, a speaker's account, speech-to-text (STT) information, the date and time of an utterance, the corresponding day of the week, and temporal information.

The user input interface unit 150 may be configured to receive the first input that has a duration shorter than the threshold time of the AI shortcut key 202 of the remote control device 200. The user input interface unit 150 may notify the recommendation utterance output module 171 of the reception of the first input. The recommendation utterance output module 171 may operate in conjunction with an account management module 173 to check information about a currently logged-in account. In this regard, the recommendation utterance output module 171 may transfer a request for the information about the currently logged-in account to the account management module 173. In response to the request for the information about the currently logged-in account, the recommendation utterance output module 171 may receive the information about the currently logged-in account from the account management module 173 and identify the currently logged-in account.

The recommendation utterance output module 171 may acquire the history of the utterance data stored in the database 140 in conjunction with the history management module 172. The recommendation utterance output module 171 may generate a recommendation utterance including a specific keyword on the basis of the information about a login-required account and the history of the utterance data. The recommendation utterance, including a specific keyword, may be generated on the basis of utterances or keywords that are frequently used by the user. In this regard, a sentence including the user's name may be displayed on a second screen of the display 180. The sentence including the user's name may be displayed in the first region, and recommendation utterances, which are based on the user's utterance history, may be displayed in the second region.

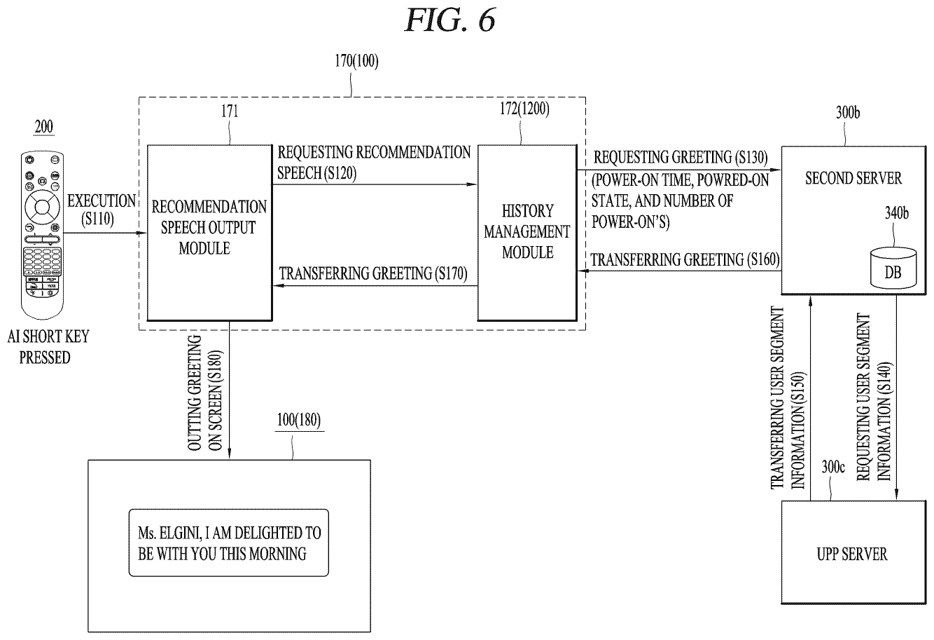

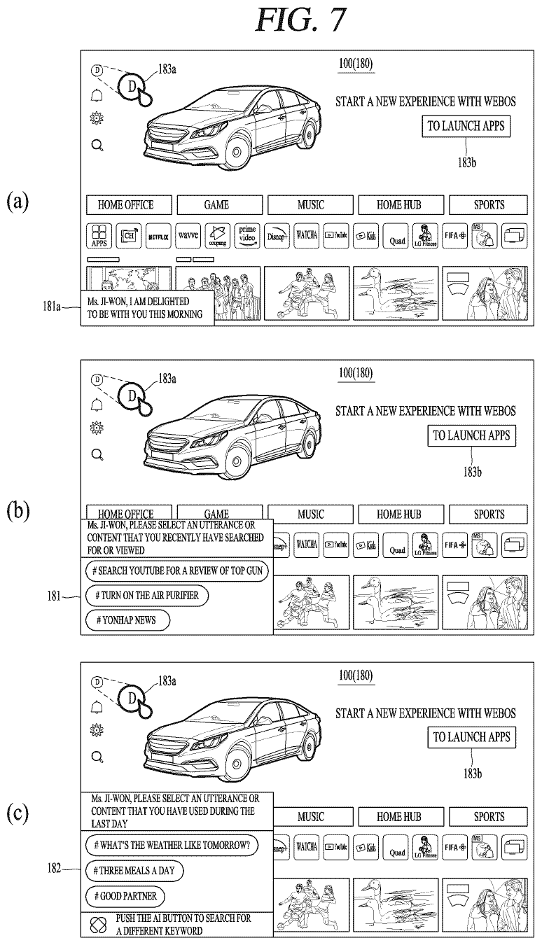

The AI system, which includes the display device 100 according to the present disclosure that operates in conjunction with utterance data, may receive, from a separate server, greetings to be provided to the user and may display the received greetings to the screen. In this regard, FIG. 6 is a diagram illustrating the configuration of the AI system that includes the display device 100 according to the present disclosure, the display device 100 receiving, from a separate server, and displaying the received greetings to the screen.

With reference to FIGS. 3 and 6, a power button 201 of the remote control device 200 may be pressed in a powered-off state or may switch to a powered-on state according to a timer setting. When the AI shortcut key 202 is pressed within a predetermined time period after being switched to the powered-on state, a greeting may be displayed on the screen of the display 180. When the AI shortcut key 202 is pressed within a predetermined time period after the power button 201 is pressed in the powered-off state, an execution input may be transferred from the remote control device 200 to the recommendation utterance output module 171 (S110).

The recommendation utterance output module 171 may transfer the recommendation utterance request to the history management module 172 (S120). The history management module 172 may transfer a greeting request to a second server 300b, which performs greeting management such that a greeting is displayed in the powered-on state (S130). When the greeting request is transferred, information regarding the time at which a switch to the powered-on state occurs, and information regarding the powered-on state and a number of power-ons may be transferred to the second server 300b. User-specific or situation-specific greetings may be stored in a greeting database 340b of the second server 300b.

The second server 300b may request user segment information from a UPP server 300C (S140). The user (customer) segment information refers to information that is obtained by classifying a plurality of users (customers) according to the user's gender, age, viewed content, and interests, using a segment (group) classification method in accordance with a predetermined reference. The UPP server 300C may be configured to store and manage information regarding user preference profiles for each user. In response to a request for the user segment information, the UPP server 300C may transfer the user segment information to the second server 300b (S150). The second server 300b may select a specific greeting from among the greetings stored in the database 340b on the basis of the user segment information, the information regarding the time at which the switch to the powered-on state occurs, and the information regarding the powered-on state and a number of power-ons.

The greeting, including “morning,” may be selected on the basis of the information regarding the time at which the switch to the powered-on state occurs. The second server 300b may select a first greeting, a second greeting, a third greeting, or so forth, each different from the others, according to the number of times the power button 201 is pressed and an interval between pressing and releasing the power button 201. In a case where the switch to the powered-on state first occurs in the morning, the second server 300b may select the greeting “Ms. Elgini, I am delighted to be with you this morning” on the basis of the user segment information and transfer the selected greeting to the history management module 172.

The history management module 172 may receive, from the second server 300b, a specific greeting selected on the basis of the user segment information, the information regarding the time at which the switch to the powered-on state occurs, and the information regarding a number of power-ons. The history management module 172 may transfer the selected specific greeting to the recommendation utterance output module 171. The recommendation utterance output module 171 may output the transferred specific greeting to the screen of the display 180.

With reference to FIGS. 1 to 6, when the button (e.g., the AI shortcut key 202) of the remote control device 200 is pressed, thereby causing reception of a key value corresponding to the pressed button, the recommendation utterance output module 171 may transfer the recommendation utterance request to the history management module 172. The history management module 172 may transfer the greeting request to the second server 300b on the basis of the information regarding the time at which the switch to the powered-on state occurs and a number of power-ons, thereby receiving a greeting from the second server 300b. The history management module 172 may transfer the received greeting to the recommendation utterance output module 171. The recommendation utterance output module 171 may output a screen, including the received greeting, on the display 180.

In the AI system that includes both the display device 100 according to the present disclosure, which operates in conjunction with utterance data, and the server 300, recommendation phrases may be output based on time when the switch to the powered-on state occurs. In this regard, (a), (b), and (c) of FIG. 7 are views, each illustrating a screen that is output on the display device 100 over the passage of time in the powered-on state.

With reference to FIG. 6 and (a) of FIG. 7, a greeting may be output on the display 180 of the display device 100 in the powered-on state. In this regard, a greeting may be output in a portion of the lower region of the display 180 in a state where a home screen is fully displayed on the display 180.

With reference to FIG. 6 and (a) and (b) of FIG. 7, in a state where the greeting is output, when a predetermined time period elapses without any user input, recommendation phrases based on the most recent search history or viewing history may be output on the display 180. In the state where the greeting is output, when no input is applied, no content application is executed, or no voice command is executed, recommendation speeds or phrases based on the most recent search history or viewing history may be output. For example, based on the recent search history, the recommendation utterance “# Search YouTube for a review of Top Gun” may be displayed with the highest priority in a portion of the lower region of the display 180. Based on the recent search history, the recommendation utterance “# Turn on the air purifier” may be displayed with the second-highest priority in the portion of the lower region of the display 180. In addition, based on the recent search history, the content “# Yonhap News” or a recommendation phrase associated with the channel may be displayed with the third-highest priority in the portion of the lower region of the display 180.

With reference to FIG. 6 and (b) and (c) of FIG. 7, after another predetermined period elapses in a state where the recommendation utterance based on the most recent search or viewing history is output, the user's search or viewing history may be extracted on a per-day, per-week, or per-month basis. Therefore, recommendation phrases, based on the user's search or viewing history on a per-day, per-week, or per-month basis, may be output on the display 180. For example, based on the search history for the past one day, the recommendation utterance “# What's the weather like tomorrow?” may be displayed with the highest priority in the portion of the lower region of the display 180. For example, based on the search history for the past one day, a recommendation utterance associated with the content “# Three meals a day” may be displayed with the second highest priority in the portion of the lower region of the display 180. In addition, based on the viewing history for the past one day, a recommendation phrase associated with the content “# Good Partner” may be displayed with the third-highest priority in the portion of the lower region of the display 180.

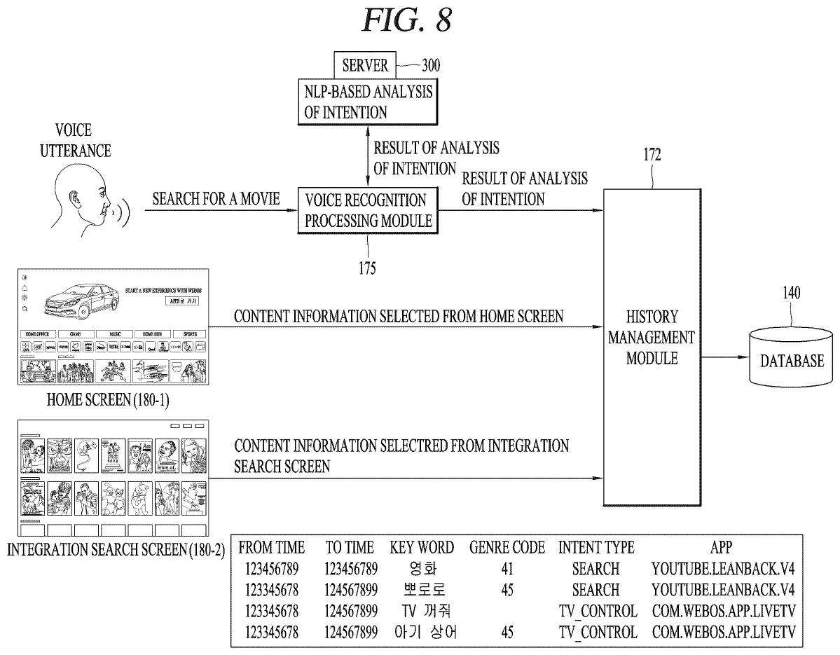

The AI system that includes both the display device 100 according to the present disclosure, which operates in conjunction with utterance data, and the server 300, may be configured to analyze the user's intention through the utterance data. In this regard, FIG. 8 is a diagram illustrating the configuration of the display device 100 configured to store historical information regarding the analysis of the user's intention through the utterance data and historical information regarding content selected from a home screen 180-1 and an integration search screen 180-2.

With reference to FIGS. 5 and 8, the voice recognition processing module 175 may recognize the user's voice command “Search for a movie” and perform processing for analysis of the intention of the recognized voice in conjunction with the server 300. The result of the analysis of the intention of the recognized utterance may be transferred from the server 300 or the utterance recognition processing module 175 to the history management module 172. The history management module 172 may store, in the database 140, temporal information, a keyword, a genre code, an intention type, and execution information of an application on the basis of the result of the analysis of the intention. In response to the voice command “Find a movie,” the keyword “movie” may be extracted, and the intention type (intentType) may be designated as “search.”

First content information regarding first content selected from the home screen 180-1 of the display 180 through the remote control device 200 may be transferred to the history management module 172. In addition, second content information regarding second content selected from the integration search screen 180-2 of the display 180 through the remote control device 200 may be transferred to the history management module 172. Content information regarding content selected from the home screen 180-1 or the integration search screen 180-2 may be transferred to the history management module 172 and stored in the database 140.

A keyword associated with the content selected from the home screen 180-1 or the integration search screen 180-2 may be selected as “PPORORO,” or “Baby Shark,” and the intention type (IntentType) may be designated as search. The intention type (IntentType) of a keyword selected through voice recognition and that of a keyword selected from the home search screen 180-1 or the integration search screen 180-2 may both be classified and designated as search. The keyword “Turn off the TV” may be extracted through voice recognition, and the intention type (IntentType) of the keyword “Turn off the TV” may be classified and designated as tv_control for powering off the display device 100.

Searching for movies and playing back the first content may be performed through a first application program, such as YouTube. In this regard, in a state where the first application program is executed in the foreground, a voice utterance may be received and recognized. From the home screen 180-1, the first application program may be selected. The playback of the second content may be performed through a second application program, such as WebOS. The playback of the second content may be performed through the second application on a channel service that is operated by a manufacturer of the display device 100. Therefore, either the result of the analysis of the intention or history management may vary depending on an application that is currently being executed on the display device 100.

With reference to FIGS. 1 to 5 and FIG. 8, processes of loading either historical information regarding a voice utterance or historical information regarding content selected from many screens are described in detail below. In this regard, the processor 170 may be configured to recognize and process voice data uttered by the user, in conjunction with the voice recognition processing module 175. The voice recognition processing module 175 may be configured to transfer the recognized utterance data from the remote control device 200 to the server 300.

When the second input, having a duration equal to or longer than the threshold time, is applied to the button (e.g., the AI shortcut key 202) of the remote control device 200, the voice recognition processing module 175 may be configured to perform processing for analysis of the user's intention on the basis of the utterance data in conjunction with the server 300. The voice recognition processing module 175 may control the display of a search result, which is associated with the recognized utterance data, on the screen of the display 180 on the basis of the result of the processing for analysis of the user's intention.

The history management module 172 may be configured to store the history of the utterance data in the database 140 on the result of the processing for analysis of the user's intention, the result being received from the server 300. The history management module 172 may be configured to store a history of content information in the database 140 based on the content information selected from the home screen of the display 180. The history management module 172 may be configured to store a history of second content information in the database 140 on the basis of the second content information selected from the integration search screen 802 of the display 180.

The utterance data, the content information, and the second content information that are to be stored in the database 140 may each include various types of information. Various types of information that are to be stored in the database 140 may each include temporal information including a start time (FromTime) and an end time (ToTime), a keyword, a genre code (genreCode), an intention type (IntentType), and information on an application (App) being executed on the display device 100.

The intention type (IntentType) may include an operation (tv_control) associated with the voice utterance, the search from the home screen or the integration search screen, or control of the display device 100 on an application associated with WebOS-based live TV. The operation (tv_control) associated with the control may be associated with a voice utterance associated with the powering-off of the display device 100 on the application associated with the live TV, or with the playback of specific content. The keyword may be at least one of the following: a keyword derived from the utterance data of the user, the content, or the name of the second content.

The voice recognition processing module 175 may control the storage of the history of the utterance data in the database 140. The history of the utterance data may include the user's account, an STT result, the date and time of an utterance, the corresponding day of the week, and temporal information. In this regard, when the button (e.g., the AI shortcut key 202) of the remote control device 200 is pressed, the processor 170 may extract the information about the currently logged-in account through the database 140. The processor 170 may extract keyword information associated with an utterance used by the user, on the basis of the current day of the week and temporal information. The processor 170 may control the output of the received recommendation utterance, including the keyword, on the display 180 on the basis of the keyword information.

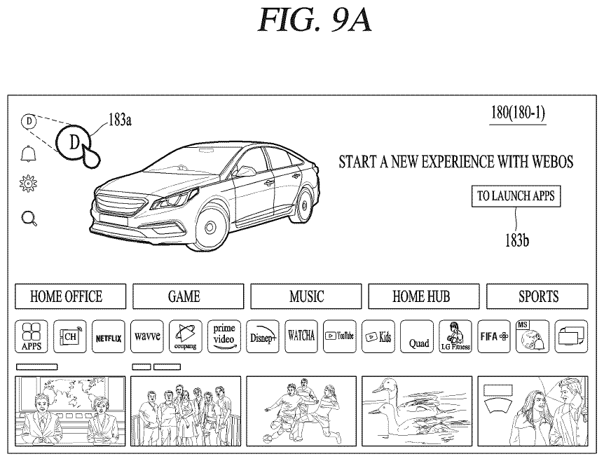

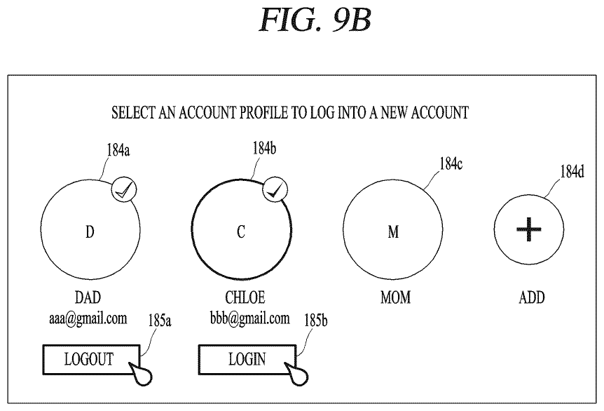

The display device 100 according to the present disclosure, which displays the customized recommendation utterance, may be configured to switch among login-required accounts of users on the basis of voiceprint data of the user who is uttering. In this regard, FIG. 9A is a view illustrating an initial screen that is displayed when a specific user logs into their login-required account. FIG. 9B is a view illustrating a screen for changing profiles of a plurality of users.

With reference to FIGS. 8 and 9A, an icon 183a associated with a first user's first login-required account may be displayed in a portion of the home screen 180-1 of the display 180. An icon 183b that enables the execution of the second application program, such as WebOS, may be displayed in another portion of the home screen 180-1 of the display 180. Icons corresponding to services provided by a plurality of content servers may be displayed on the display 180 in a distinctively categorized manner. The icons corresponding to the services provided by the plurality of content servers may be displayed in mutually distinct categories including home office, gaming, music, home hub, and sports.

With reference to FIG. 9B, icons 184a, 184b, 184c, and 184d, which are associated with respective user profiles of a plurality of users, may be in specific regions of the display 180. Depending on a selection input to the icon 183a associated with the first login-required account, the icons 184a, 184b, 184c, and 184d, each representing a respective login-required account of a family member, may be displayed on the screen. The icon 184a associated with the first user's first login-required account may be displayed on the screen, the first user corresponding to Dad. For example, the first user's first login-required account may be aaa@gmail.com. An icon 185a for logging out from the first user's first login-required account may be displayed in the lower portion of the icon 184a associated with the first user's profile.

The icon 184b associated with a second user's second login-required account may be displayed on the screen, the second user corresponding to Chloe. For example, the second user's second login-required account may be bbb@gmail.com. The icon 184c associated with a third user's third login-required account may be displayed on the screen, the third user corresponding to Mom. In addition, the icon 184d for generating a fourth user's fourth login-required account may be displayed on the screen.

With reference to FIG. 1 and FIGS. 8 to 9A, a configuration and operation of the display device 100 that displays the customized recommendation utterance and switches among the users'login-required accounts on the basis of voiceprint data of the user who is uttering are described.

The voice recognition processing module 175 may determine, in conjunction with the server 300, whether the recognized utterance data is voiceprint data of the second user other than the user in a logged-in state. When the second user is a registered user, the processor 170 may display an account switch screen in FIG. 9B, which is associated with whether to perform a switch from the user's login-required account to the second user's second login-required account. When a switch input for the switch from the account switch screen in FIG. 9B to the second login-required account is received, the processor 170 may switch to the second login-required account.

A first selection box 185a associated with logging out of the first login-required account may be displayed under the first icon 184a for the first user's first login-required account, the first user corresponding to Dad. When the first selection box 185a is selected, the first login-required account may be switched to a logged-out state, and the second user's second login-required account may be automatically switched to a logged-in state.

A second selection box 185b associated with logging into the second login-required account may be displayed under the second icon 184b for the second user's second login-required account, the second user corresponding to Chloe. When the second selection box 185b is selected, a switch to the second user's second login-required account may be performed, and the first login-required account may be automatically switched to a logged-out state.

The display device 100 according to this disclosure may recognize the user and display a recommendation utterance customized on a per-user basis. With reference to FIGS. 3 to 9B, the display device 100 according to the present disclosure, which displays the recommendation utterance customized on a per-user basis, is described. The processor 170 may detect whether the first user is an authenticated user in a state where the first user's first login-required account, among a plurality of user accounts, is logged in. When the first user is detected, the processor 170 may request a first recommendation utterance from the server 300 on the basis of both a first history of the first user's first utterance data and first account information. In this regard, a first identifier of the first user's first device and the first user's voiceprint data or face may be detected, thereby enabling detection of the first user.

The processor 170 may detect whether the second user is an authenticated user in a state where the second user's second login-required account, among the plurality of user accounts, is logged in. When the second user is detected, the processor 170 may request a second recommendation utterance from the server 300 on the basis of both a second history of second utterance data of the second user and second account information of the second user. In this regard, a second identifier of the second user's second device and the second user's voiceprint data or face may be detected, thereby enabling detection of the second user.

The processor 170 may determine whether the second user is detected instead of the first user in a state where logging into the first login-required account is performed. When the second user is detected instead of the first user, the processor 170 may display a screen for determining whether to switch to the second user's second login-required account. When the second user is detected instead of the first user, the processor 170 may request the second recommendation utterance from the server 300 on the basis of the second history and second account information.

The processor 170 may determine whether the first user and the second user are detected in a state where logging into the first login-required account is performed. When the first and second users are detected, the processor 170 may request the first and second recommendation utterances from the server 300 on the basis of the first history, the second history, the first account information, and the second account information. In this regard, the processor 170 may determine, through user profile information, whether the second user is registered as having a familial relationship with the first user.

When the second user is registered as having a familial relationship with the first user, the processor 170 may display a common recommendation utterance on the display 180 on the basis of a keyword common to the first recommendation utterance and the second recommendation utterance. The processor 170 may display the first recommendation utterance after the common recommendation utterance on the basis of the first user's first keyword. The processor 170 may display the second recommendation utterance after the first recommendation utterance on the basis of the second user's second keyword.

When the first and second users are detected and the second user is not registered as having a familial relationship with the first user, the processor 170 may display the common recommendation utterance on the display 180 on the basis of the keyword common to the first recommendation utterance and the second recommendation utterance. The processor 170 may determine, on the basis of a first user input, whether to display the first recommendation utterance on the basis of the first user's first keyword. When the first user input is received, the processor 170 may display the first recommendation utterance on the screen after the common recommendation utterance.

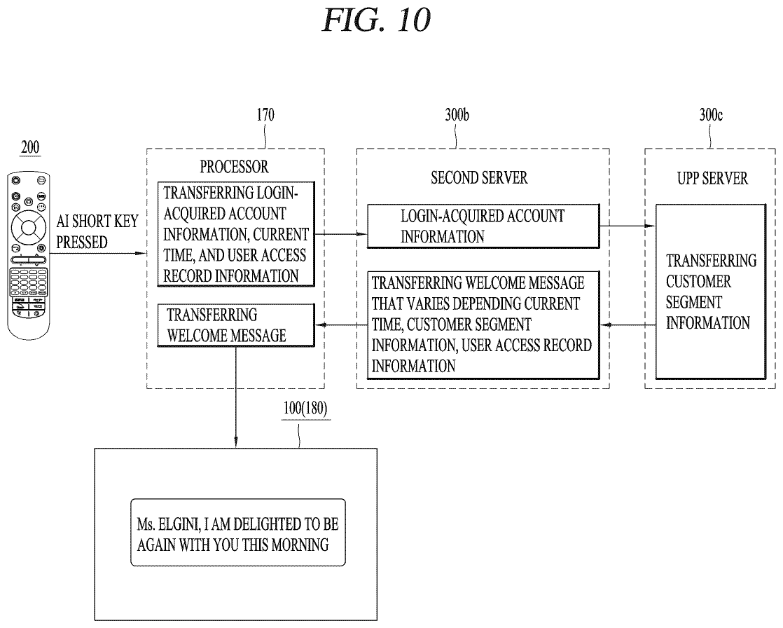

The AI system that includes both the display device 100, according to the present disclosure, which operates in conjunction with the utterance data, and the server 300, may provide a recommendation service customized based on a user or situation, and a usage tip service. In this regard, FIG. 10 is a diagram illustrating a recommendation service, according to an embodiment, which is customized based on the user or situation. With reference to FIGS. 3, 6, and 10, when the AI shortcut key 202 is pressed within a predetermined time period after the switch to the powered-on state, a greeting may be displayed on the screen of the display 180. When the AI shortcut key 202 is pressed, current login-acquired account information, the current time, and user access record information may be transferred from the remote control device 200 to the processor 170.

The second server 300b may transfer the login-acquired account information to a UPP server 300C. The UPP server 300C may acquire customer segment information on the basis of the login-acquired account information and transfer the acquired customer segment information to the second server 300b. The second server 300b may generate and recommend a welcome message that varies depending on the current time, the customer segment information, and the user access record information. The processor 170 may transfer the welcome message received from the second server 300b to the display 180 and control the display 180 such that the welcome message is output on the screen. Therefore, the welcome message, “Ms. Elgini, I am delighted to be with you this morning,” may be displayed on the screen of the display 180.

The display device 100 may display a greeting, that is, a welcome message that varies depending on the time at which the switch to the powered-on state occurs and a number of power-ons. With reference to FIGS. 1 to 6, the processor 170 determines whether the switch from the powered-off state to the powered-on state first occurs on a per-date basis. When the switch to the powered-on state first occurs, the processor 170 may output a screen including a first greeting on the display 180 on the basis of temporal information. When the switch to the powered-on state first occurs, the first greeting may be generated in the form of the sentence “Ms. Elgini, I am delighted to be with you this morning,” as illustrated in FIG. 6.

When the switch to the powered-on state occurs two or more times, the processor 170 may display, on the screen 180, a screen including a second greeting different from the first greeting. When the switch to the powered-on state occurs two or more times, the second greeting on temporal information may be generated in the form of the sentence “Ms. Elgini, I am delighted to be again with you this morning,” as illustrated in FIG. 10.

When a predetermined time period elapses in a state while the first or second greeting is displayed in the powered-on state, recommendation utterances in FIGS. 4 and 5 may be displayed on the screen. With reference to FIGS. 1 to 5, the processor 170 displays, on the screen, a sentence that includes the user's name (e.g., Ms. Ji-Won, please select an utterance that is frequently used during the past week). The sentence including the user's name may be displayed in the first region, and recommendation utterances, which are based on the user's utterance history, may be displayed in the second region.

In this regard, when a first threshold time elapses in the powered-on state, the processor 170 may extract keywords according to utterance frequency derived from the history of the utterance data for each corresponding week. The processor 170 may display the extracted keywords in order of the utterance frequency. The recommendation utterances may be displayed with the keyword being combined with a hashtag. The recommendation utterances may be displayed such that a sentence including the keyword is displayed in combination with the hashtag. Respective keywords of the recommendation utterances may be the first content and the second content (the first program and the second program) that may be viewed through the display device 100. Additionally, the keyword of the recommendation utterance may be a sentence uttered by the user, for example, “What's the weather like tomorrow?”

With reference to FIGS. 1 to 10, the processor 170 may transfer the information about the currently logged-in account, the current time, and the user's access record to the second server 300b. The second server 300b may transfer the account information to the UPP server 300c and then receive the customer segment information from the UPP server 300c. The second server 300b may transfer a welcome message, which is generated on the basis of the current time, the customer segment information, and the user's access history, to the processor 170. The processor 170 may control the output of the welcome message on the display 180.

Therefore, the processor 170 may provide a situation-customized recommendation function. In this regard, when the display device 100 is powered on, a situation-customized welcome greeting may be provided based on a time span of the powered-on state, the frequency of powering on or powering off, an interval between powering on and powering off, and segment information for each time span during which the display device 100 is most used.

In addition, a function that is performable immediately in the powered-on state of the display device 100 may be preferentially recommended. While the display device 100 is in use, a keyword most suitable for a corresponding situation may be recommended by analyzing an application in use or content being viewed. Another application or setting having a high correlation may be proposed as a usage tip, according to the characteristics of the application currently in use. Through the title, genre, and metadata information of the content being watched, association keywords associated with viewing, such as cast, director, viewership ratings, and OST, may be provided.

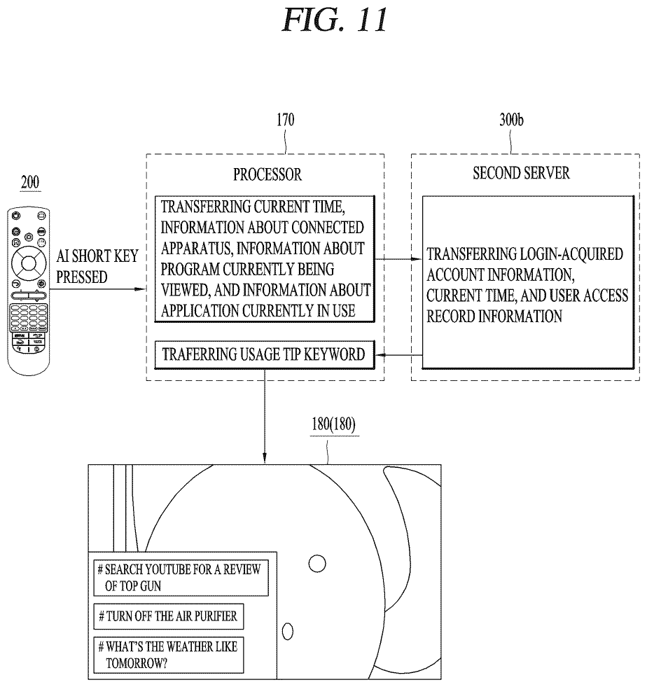

The display device 100, according to the present disclosure, that displays the customized recommendation utterance, and the AI system, including the display device 100, may provide a usage tip service customized based on the user or situation. In this regard, FIG. 11 is a diagram illustrating a configuration, according to an embodiment, which provides the usage tip service customized based on the user or a situation. With reference to FIGS. 3 and 11, when the AI shortcut key 202 is pressed, a usage tip phrase that is obtained by considering a program being viewed and an application in use may be displayed on the screen of the display 180. When the AI shortcut key 202 is pressed, the processor 170 may transfer the current time, information about the connected apparatus, information about a program currently being viewed, and information about an application currently in use to the second server 300b. In this regard, the processor 170 may receive usage tip information selected based on the identifier of the connected device and state information thereof.

The second server 300b may generate and recommend the usage tip information customized on the basis of the current time, the information about the connected apparatus, the information about the program currently being viewed, and the information about the application currently in use. The processor 170 may receive the customized usage tip information or a usage tip keyword associated therewith from the second server 300b.

The processor 170 may transfer the usage tip keyword received from the second server 300b to the display 180 and control the display 180 such that the usage tip keyword is output on the screen. Therefore, the usage tip information items “Please find a Top Gun review on YouTube,” “Please turn off the air purifier,” and “What's the weather like tomorrow?” may be displayed on the screen of the display 180.

In this regard, when the first application program, YouTube, is currently being executed in the foreground on the display device 100, the user tip information “Find Top Gun review on YouTube” may be displayed on the screen of the display 180.

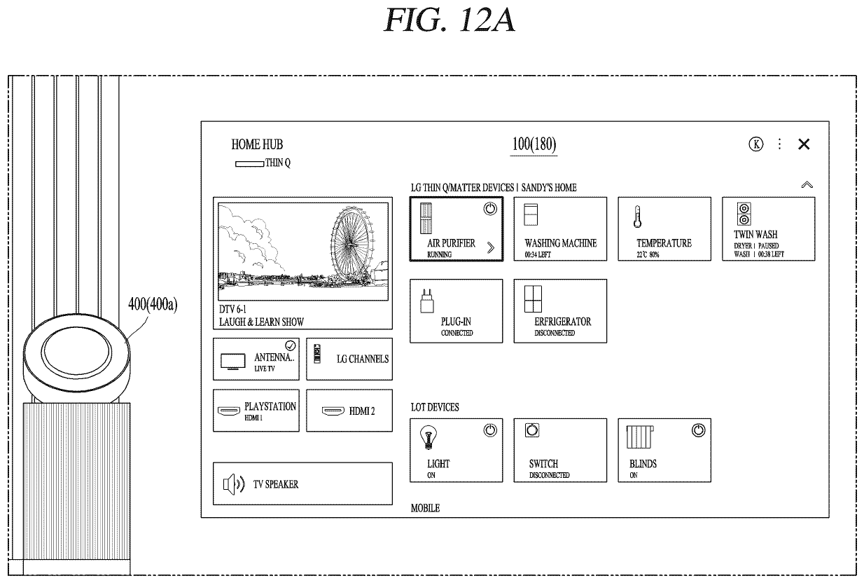

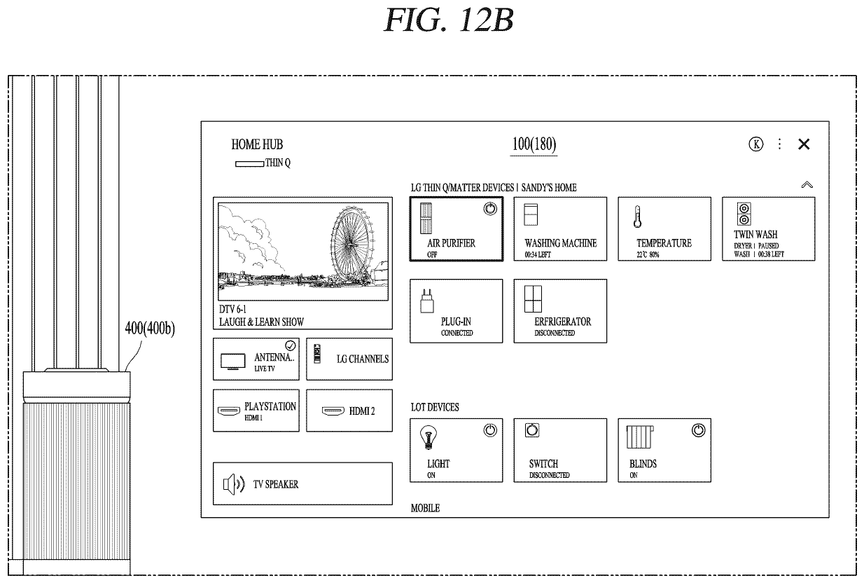

When the display device 100 is connected to an air purifier, the usage tip information “Please turn off the air purifier” may be displayed on the screen of the display 180. In this regard, FIGS. 12A and 12B are views, each illustrating the screen of the display device 100 that displays state information of an apparatus connected to the display device 100.

With reference to FIGS. 12A and 12B, state information items of an air purifier, a washing machine, a dryer, and a refrigerator may be displayed on the display 180 of the display device 100. In addition, state information items of a light, a switch, and blinds may be displayed on the display 180.

With reference to FIG. 12A, the air purifier may be one of the apparatuses 400 connected to the display device 100. As displayed on a control screen of a home hub of the display 180, the air purifier may be in an operating state 400a. With reference to FIG. 12B, the operating states of the apparatuses 400 connected to the display device 100 may be changed. As displayed on the control screen of the home hub of the display 180, the air purifier may be in an off state 400b. In this regard, as illustrated in FIG. 11, the user tip information “Turn off the air purifier” may be selected from the screen of the display 180.

As illustrated in FIG. 11, when the AI shortcut key 202 of the remote control device 200 is pressed, a user-customized menu, such as a usage tip, may be provided either on the screen or via voice. Alternatively, user voice may be recognized depending on the manner in which the AI shortcut key 202 is pressed. Therefore, among the apparatuses 400 connected to the display device 100, the operation of an apparatus that may cause interference with voice recognition or audio output may be temporarily suspended. Therefore, when the AI shortcut key 202 of the remote control device 200 is pressed, the usage tip information “Please turn off the air purifier” may be displayed on the screen of the display 180. Accordingly, when the user tip information “Please turn off the air purifier” is selected, as illustrated in FIGS. 12A and 12B, the air purifier, among the apparatuses 400 connected to the display device 100, may switch from the operating state 400a to the off state 400b.

In this regard, when a user input for selecting the usage tip information “Please turn off the air purifier” is applied, the display 180 may switch from the screen in FIG. 11 to the screen in FIG. 12B. A screen switch and a state switch are not limited to being triggered by the user input. When a cancellation input is not received within a predetermined time period, the air purifier may also automatically switch to the off state 400b.

The usage tip information “Please turn off the air purifier” may be displayed on the screen of the display 180 on the basis of state information of the air purifier. In this regard, when it is determined that the air purifier has been operating for a predetermined time period and that the current concentration of fine particles in the indoor air is equal to or lower than a threshold value, the state information of the air purifier and an air purification state may be determined to be normal. When the state information of the air purifier and the air purification state are normal, the usage tip information “Please turn off the air purifier” may be displayed on the screen of the display 180.

When the air purifier is in an off state and the concentration of fine particles in the indoor air is determined to be higher than the threshold value, the usage tip information “Please turn on the air purifier” may also be displayed on the screen of the display 180. When the usage tip information “Please turn on the air purifier” is selected, the screen of the display 180 may switch from the screen in FIG. 11 to the screen in FIG. 12A.

With reference to FIGS. 1 to 12B, the processor 170 may detect whether the button (e.g., the AI shortcut key 202) of the remote control device 200 is pressed. When the first input through the AI shortcut key 220 is detected, the processor 170 may transfer, to the second server 300b, the current time, the information about the connected apparatus, the information about the program currently being viewed, and the information about the application currently in use. The processor 170 may receive, from the second server 300b, the usage tip information customized on the basis of the current time, the information about the connected apparatus, the information about the program currently being viewed, and the information about the application currently in use. The processor 170 may control the output of at least one sentence associated with a usage tip on the display 180 on the basis of the customized usage tip information.

The customized usage tip information and the recommendation utterance may be provided on the basis of a user-customized keyword for each account. Regarding the user-customized keyword for each account, user data may be managed based on the user account, and, during a voice search, a preference for each account may be learned through voiceprint recognition. The user-customized keyword may be recommended through integrated inference from user data, the user data including: a history of voice utterances; content for viewing; TV settings, data relating to home IoT apparatus connected in a household; and preference segments classified according to usage patterns. User preference may be analyzed based on the user data accumulated on a per-day or per-time basis, and the recent information of interest may be continuously updated based on the latest data. With respect to content, to provide a recommendation based on the user's preferred genre, an optimal recommendation may be generated by utilizing content preference information of a cluster of users who view the same content.

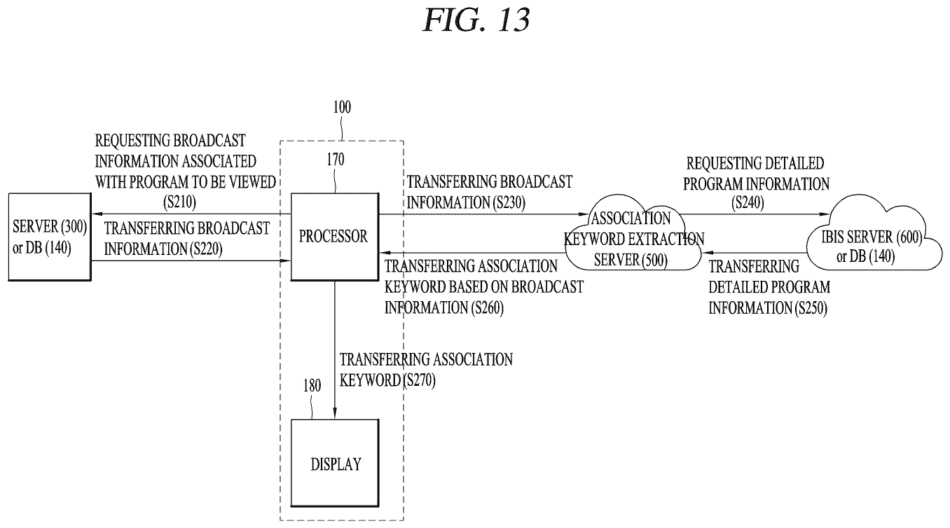

The AI system that includes both the display device 100, according to the present disclosure, that operates in conjunction with utterance data, and the server 300 may be configured to provide an association keyword recommendation service based on broadcast information. In this regard, FIG. 13 is a diagram illustrating the configuration of an AI system, according to an embodiment, that provides a service for recommending an association keyword based on the broadcast information.

With reference to FIG. 13, the AI system may be configured to include the display device 100, the server 300, the third server 500 for extracting an association keyword, and the fourth server 600 associated with an integrated broadcasting information system (IBIS). The display device 100 may include the processor 170 that requests and receives information in conjunction with the servers, and the display 180 that displays the association keyword.

The processor 170 may request broadcast information about a program to be viewed from the server 300 or the database 140 (S210). The broadcast information received from the server 300 or the database 140 may be transferred to the display device 100 (S220). The processor 170 may receive the broadcast information from the server 300 or the database 140. In this regard, an entity that manages the broadcast information of the viewed program may be the server 300 or the database 140 of the display device 100.

The processor 170 may transfer the broadcast information to the third server 500 that extracts the association keyword (S230). The third server 500 may request detailed program information from the fourth server 600 associated with the IBIS or from the database 140 (S240). The fourth server 600 or the database 140 may transfer the detailed program information to the third server 500 (S250). The third server 500 may transfer an association keyword based on the broadcast information, the association keyword being extracted on the basis of the detailed program information, to the display device 100 (S260). The processor 170 may transfer the association keyword based on the broadcast information to the display 180 (or a screen output unit) such that the association keyword is output on the display 180.

With reference to FIGS. 1 to 13, the processor 170 may be configured to receive broadcast information, associated with a program to be viewed by the user, from the server 300. The processor 170 may be configured to transfer the broadcast information to the third server 500 that extracts an association keyword related to the broadcast information. The third server 500 may request the detailed program information associated with the broadcast information from the fourth server 600 of the integrated broadcasting information system. In response to the request, the third server 500 may be configured to receive the detailed program information associated with the broadcast information from the fourth server 600. The processor 170 may be configured to output the association keyword related to the broadcast information on the display 180 on the basis of the detailed program information.

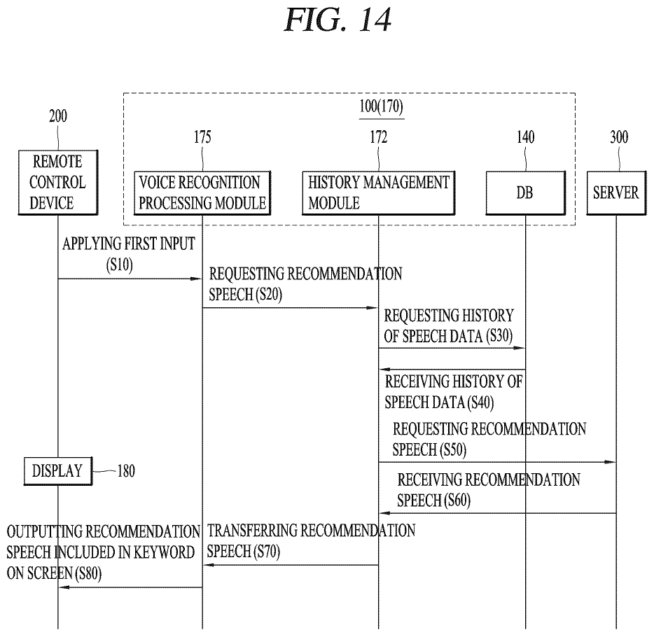

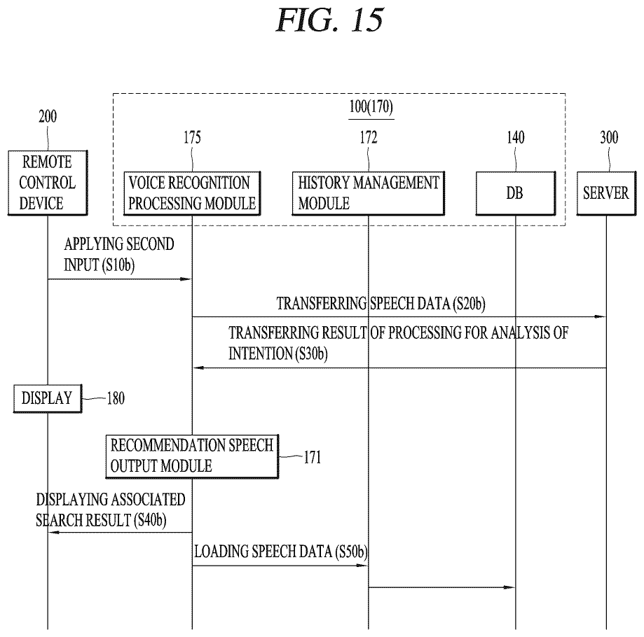

A method of displaying the customized recommendation speed, the method being performed by the display device 100 according to the present disclosure and by the AI system including the display device 100, is described. In this regard, FIG. 14 is a flowchart illustrating the method of displaying the customized recommendation utterance, the method being performed by the display device 100 and by the AI system including the display device 100. FIG. 15 is a flowchart illustrating a method of displaying an association search result based on the analysis of the user's intention identified through voice recognition, the method being performed by the display device 100 and by the AI system including the display device 100. With reference to FIGS. 1 to 15, the method of displaying the result of the association search may be performed by the processor 170 of the display device 100.

When the button (the AI shortcut key 220) of the remote control device 200 is pressed for the first time shorter than the threshold time, and thus the first input is applied (S10), the processor 170 may generate the recommendation utterance request. The recommendation utterance output module 171 may transfer the generated recommendation utterance request to the history management module 172 (S20). In response to the recommendation utterance request, the history management module 172 may request the history of the previous utterance data from the database 140 (S30). The history management module 172 may receive the history of the previous utterance data from the database 140 (S40).

The history management module 172 may request the recommendation utterance from the server 300 on the basis of the history of the utterance data and the account information of the user (S50). The history management module 172 may receive the recommendation utterance from the server 300 (S60). The history management module 172 may transfer the received recommendation utterance to the recommendation utterance output module 171 (S70). The recommendation utterance output module 171 may control the display of the received recommendation utterance, including a keyword, on the screen of the display 180.

When the button (the AI shortcut key 202) of the remote control device 200 is pressed for the second time equal to or longer than the threshold time, and thus the second input is applied (S10b), the processor 170 may recognize the utterance data (voice) of the user through the voice recognition processing module 175. The voice recognition processing module 175 may transfer the recognized utterance data to the server 300 (S20b).

The voice recognition processing module 175 and the recommendation utterance output module 171 may receive, from the server 300, the result of the processing for analysis of the user's intention associated with the recognized utterance data (S30b). The recommendation utterance output module 171 may control the display of a search result, associated with the recognized utterance data, on the screen of the display 180 on the basis of the result of the processing for analysis of the user's intention (S40b). The voice recognition processing module 175 and the recommendation utterance output module 171 may control the loading of the utterance data onto the database 140 through the history management module 172 (S50b). The history management module 172 may request the history of the utterance data (S30). In response to this request, the history of the utterance data stored in the database 140 may be transferred to the history management module 172 (S40).

The method of displaying the result of the association search, according to another aspect of the present disclosure, the method being performed by the display device 100 that displays the customized recommendation utterance, is not limited to the foregoing description, and may be variously applicable in combination with embodiments in FIGS. 1 to 12.

The display device 100, according to the present disclosure, that displays the customized recommendation utterance and the AI system that includes the display device 100 have been described above. The technical effects of the display device, according to the present disclosure, that displays the customized recommendation utterance and of the AI system, including the display device, may be summarized as follows, but are not limited to this summary.

According to the present disclosure, a recommendation customized for each user can be provided by managing usage data for each account. Furthermore, user identification through voiceprint recognition enables data learning for each user solely through utterance without the need for a separate login process.

According to the present disclosure, the customized recommendation can be immediately received by pressing an AI key at any time and in any location. Enhancing recommendation accuracy through advanced logic can significantly reduce search time, thereby enabling execution of a desired function or access to desired content.

According to the present disclosure, either a setting or association information optimized for content currently being viewed can be provided. Furthermore, a usage tip for enhancing the usefulness of an application currently in use can be provided, thereby making the TV viewing experience more immersive and enjoyable.

The display device, according to the present disclosure, that displays a customized recommendation utterance may be referred to as an AI concierge that performs an AI function. The AI concierge can provide a user segment or a situation-dependent customized greeting when the display device is powered on. In addition, while the display device is in use, the recommendation utterance, including user-specific and situation-based customized keywords, can be recommended according to the user's intention and the usage context. The recommendation utterance can be displayed on a screen of the display device in order to recommend a setting, content, and similar items, as well as a keyword and a specific function.

Regarding a user-customized keyword for each account, the user data can be managed based on a user account, and, during a voice search, a preference for each account may be learned through voiceprint recognition. The user-customized keyword may be recommended through integrated inference from the user data including: a history of voice utterances; content for viewing; TV settings, data relating to home IoT apparatus connected in a household; and preference segments classified according to usage patterns. User preference can be analyzed based on the user data accumulated on a per-day or per-time basis, and the recent information of interest may be continuously updated based on the latest data. With respect to content, to provide a recommendation based on the user's preferred genre, an optimal recommendation can be generated by utilizing content preference information of a cluster of users who view the same content.

In this regard, when the display device is powered on, a situation-customized welcome greeting can be provided based on a time span of a powered-on state, the frequency of powering on or powering off, an interval between powering on and powering off, and segment information for each time span during which the display device is most used. In addition, a function that is performable immediately in the powered-on state of the display device can be preferentially recommended. While the display device is in use, a keyword most suitable for a corresponding situation can be recommended by analyzing an application in use or content being viewed. Another application or setting having a high correlation can be proposed as a usage tip, according to the characteristics of the application currently in use. Through the title, genre, and metadata information of the content being watched, association keywords associated with viewing, such as cast, director, viewership ratings, and OST, can be provided.

The present disclosure may be embodied in the form of computer-readable code on a medium on which a program is recorded. The computer-readable media include all types of recording devices capable of storing data that are readable by a computer system. Examples of media readable by computers include HDD (Hard Disk Drive), SSD (Solid State Disk), SDD (Silicon Disk Drive), ROM, RAM, CD-ROM, magnetic tape, floppy disk, and optical data storage devices. In addition, the examples encompass forms implemented as carrier waves (e.g., transmission via the Internet). In addition, the computer may include a control unit of a terminal. Therefore, the detailed description should not be interpreted in a limited manner in all respects and should be considered as serving the purpose of illustration. The scope of the present disclosure should be determined by the proper interpretation of the following claims. All equivalent modifications to the embodiments of the present disclosure fall within the scope of the present disclosure.

What is claimed is:

1. A display device capable of displaying a customized recommendation utterance, the display device comprising:
a user input interface unit configured to receive a first input, associated with a recommendation utterance request, and a second input, associated with recognition of utterance data of a user, in conjunction with a remote control device;
a display configured to display either information or a recommendation utterance, each of which is associated with the utterance data; and
a processor configured to enable the display to display a keyword associated with either the utterance data or previous utterance data of the user,
wherein, when a key value corresponding to a button of the remote control device is received, the processor
generates the recommendation utterance request,
requests a history of the previous utterance data from a database in response to the recommendation utterance request,
requests the recommendation utterance from a server on the basis of a history of the utterance data and account information of the user,
receives the recommendation utterance from the server, and
controls the output of the received recommendation utterance, including the keyword, on the display.

2. The display device of claim 1, wherein the processor comprises:
a recommendation utterance output module configured to output the recommendation utterance by executing an application program when a first input, having a duration shorter than a threshold time, is applied to the button; and
a history management module configured to receive the recommendation utterance request from the recommendation utterance output module and receive the history of the utterance data from the database,
wherein the history management module transfers the recommendation utterance, received from the server, to the recommendation utterance output module.

3. The display device of claim 2, wherein, when a key value corresponding to a power button of the remote control device is received, the recommendation utterance output module transfers the recommendation utterance request to the history management module,
the history management module transfers a greeting request to a second server and receives, from the second server, a greeting based on temporal information,
the history management module transfers the received greeting to the recommendation utterance output module, and
the recommendation utterance output module outputs a screen, including the received greeting, on the display.

4. The display device of claim 3, wherein, when a switch from a powered-off state to a powered-on state first occurs on a per-date basis, the processor outputs a screen, including a first greeting, on the display on the basis of the temporal information,
wherein, when the switch to the powered-on state occurs two or more times, the processor outputs, on the display, a screen including a second greeting different from the first greeting, and
wherein, when a first threshold time elapses in the powered-on state, the processor extracts keywords according to utterance frequency derived from the history of the utterance data for each corresponding week and displays the extracted keywords in order of the utterance frequency.

5. The display device of claim 2, wherein the processor further comprises:
a voice recognition processing module configured to transfer the recognized utterance data from the remote control device to the server, and
wherein the voice recognition processing module performs processing for analysis of the user's intention associated with the recognized utterance data in conjunction with the server when a second input, having a duration equal to or longer than the threshold time, is applied to the button, and controls the display of a search result, associated with the recognized utterance data, on a screen of the display on the basis of the result of the processing for analysis of the user's intention.

6. The display device of claim 5, wherein the voice recognition processing module determines, in conjunction with the server, whether the recognized utterance data is voiceprint data of a second user other than the user,
wherein, when the second user is a registered user, the processor displays an account switch screen, associated with whether to perform a switch from the user's login-required account to the second user's second login-required account, and
wherein, when a switch input for the switch to the second login-required account is received from the account switch screen, the processor switches to the second login-required account.

7. The display device of claim 6, wherein the processor
requests a second recommendation utterance from the server on the basis of a second history of utterance data of the second user and second account information of the second user,
receives the second recommendation utterance from the server, and
controls the output of the received second recommendation utterance, including a second keyword, on the display.

8. The display device of claim 7, wherein the history management module
stores the history of the utterance data in the database on the basis of the result of the processing for analysis of the user's intention,
stores a history of content information in the database on the basis of the content information selected from a home screen of the display, and
stores a history of second content information in the database on the basis of the second content information selected from an integration search screen of the display.

9. The display device of claim 8, wherein the utterance data, the content information, and the second content information, which are to be stored in the database, each include temporal information including a start time and an end time, a keyword, a genre code, an intention type, and information on an application being executed on the display device, and
wherein the keyword is one of the following: a keyword derived from the utterance data, the content, or the name of the second content.

10. The display device of claim 5, wherein the voice recognition processing module controls the storage of the history of the utterance data in the database, and
wherein the history of the utterance data includes the user's account, an STT result, the date and time of an utterance, the corresponding day of the week, and temporal information.

11. The display device of claim 10, wherein, when the key value corresponding to the button is received, the processor extracts information about a currently logged-in account from the database, extracts keyword information associated with an utterance used by the user, on the basis of the current day of the week and the temporal information, and controls the output of the received recommendation utterance, including the keyword, on the display on the basis of the keyword information.

12. The display device of claim 3, wherein the processor transfers, to the second server, information about a currently logged-in account, the current time, and the user's access record,
wherein the second server transfers the information about the currently logged-in account to an UPP server, receives customer segment information from the UPP server, and transfers, to the processor, a welcome message generated on the basis of the current time, the customer segment information, and the user's access record, and
wherein the processor controls the output of the welcome message on the display.

13. The display device of claim 3, wherein, when the key value corresponding to the button is received, the processor
transfers, to the second server, the current time, information about a connected apparatus, information about a program currently being viewed, and information about an application currently in use,
receives, from the second server, usage tip information customized on the basis of the current time, the information about the connected apparatus, the information about the program currently being viewed, and the information about the application currently in use, and
displays at least one sentence associated with a usage tip on the display on the basis of the customized usage tip information.

14. The display device of claim 13, wherein the processor acquires the information about the application in use and the account information of the user and outputs at least one sentence, associated with searching for and playing back content items provided by the application, on a screen of the display on the basis of the information about the application currently in use, the history of the utterance data, and the account information of the user.

15. The display device of claim 13, wherein the processor acquires state information of the connected apparatus and environmental information of a region where the display device and the connected apparatus are arranged, and outputs at least one sentence, associated with the usage tip for controlling the operation of the connected apparatus, on a screen on the basis of the state information and the environmental information.

16. The display device of claim 3, wherein the processor receives, from the server, broadcast information associated with a program to be viewed by the user, and transfers the broadcast information to a third server that extracts an association keyword associated with the broadcast information, and
wherein the third server receives detailed program information associated with the broadcast information from a fourth server of an integrated broadcasting information system, and the processor outputs the association word associated with the broadcast information on the display on the basis of the detailed program information.

17. The display device of claim 1, wherein, when a first user is detected in a state where the first user's first login-required account, among a plurality of user accounts, is logged in, the processor requests a first recommendation utterance from the server on the basis of a first history of first utterance data of the first user and first account information of the first user,
wherein, when a second user is detected in a state where the second user's second login-required account, among the plurality of user accounts, is logged in, the processor requests a second recommendation utterance from the server on the basis of a second history of second utterance data of the second user and second account information of the second user,
wherein the first user is detected by detecting a first identifier of the first user's first device or through the first user's voiceprint data, and
wherein the second user is detected by detecting a second identifier of the second user's second device or through the second user's voiceprint data.

18. The display device of claim 17, wherein, when the second user is detected instead of the first user in the state where the first login-required account is logged in, the processor requests the second recommendation utterance from the server on the basis of the second history and the second account information,
wherein, when the first user and the second user are detected in the state where the first login-required account is logged in, the processor
requests a first recommendation utterance and the second recommendation utterance from the server on the basis of the first history, the second history, the first account information, and the second account information,
displays a common recommendation utterance on the display on the basis of a keyword common to the first recommendation utterance and the second recommendation utterance, and
displays the first recommendation utterance after the common recommendation utterance on the basis of the first user's first keyword, and
wherein the second is registered as having a familial relationship with the first user.
